(19) United States
(12) Patent Application Publication
(10) Pub. No.: US 2025/0282226 A1
(43) Pub. Date: Sep. 11, 2025

(54) ELECTRIFIED VEHICLE

(71) Applicant: TOYOTA JIDOSHA KABUSHIKI KAISHA, Toyota-shi (JP)

(72) Inventors: Masaru KIMURA, Toyota-shi (JP); Yuji Matsusaka, Okazaki-shi (JP)

(73) Assignee: TOYOTA JIDOSHA KABUSHIKI KAISHA, Toyota-shi (JP)

(21) Appl. No.: 18/983,927

(22) Filed: Dec. 17, 2024

(30) Foreign Application Priority Data
Mar. 7, 2024 (JP) 2024-034997

(51) Int. Cl. B60L 3/04; B60L 3/00; B60L 50/60; B60L 53/80; E05B 81/08; E05B 81/18; E05B 81/72; E05B 83/00; H01M 50/249; H01M 50/262; H01M 50/271

(52) U.S. Cl. CPC B60L 3/04; B60L 3/0046; B60L 50/60; B60L 53/80; E05B 81/08; E05B 81/18; E05B 81/72; E05B 83/00; H01M 50/249; H01M 50/262; H01M 50/271; H01M 2220/20

(57) ABSTRACT

The disclosed electrified vehicle includes at least one replaceable battery, an electric motor that exchanges electric power with the battery, a battery case, a lock device, and a notification device, wherein the battery case includes a case body having an opening into which the battery is inserted and removed, and a lid that opens and closes the opening of the case body, and the lock device locks the lid of the battery case in such a manner that the lid is not openable, and the notification device notifies that the lid is locked when the lid is locked by the lock device so as not to be openable in response to a request from electrified vehicle.

### CROSS-REFERENCE TO RELATED APPLICATION

This application claims priority to Japanese Patent Application No. 2024-034997 filed on Mar. 7, 2024, incorporated herein by reference in its entirety.

### BACKGROUND

### 1. Technical Field

The present disclosure relates to electrified vehicles configured to travel with power from an electric motor that transfers electric power to and from a replaceable battery.

### 2. Description of Related Art

A battery electric vehicle having a battery compartment under the floor of a vehicle cabin is known in the art (see, for example, Japanese Unexamined Patent Application Publication No. 2022-115495 (JP 2022-115495 A)). A plurality of battery packs (batteries) with a maximal voltage of 50V or less is mounted in the battery compartment of the battery electric vehicle. These battery packs are detachably connected in series or in parallel with each other. A battery load and unload opening with an open and close door is provided next to the driver's seat of the battery electric vehicle. The operator opens the open and close door to load the battery packs into or unload the battery packs from the battery compartment through the battery load and unload opening.

### SUMMARY

In order to protect the battery packs and avoid contact with the battery packs, it is preferable that the open and close door for the battery load and unload opening be locked so as not to be openable except when unloading and loading the battery packs. Depending on the state of the battery packs and their related equipment, it is sometimes preferable to lock the open and close door for the battery load and unload opening in such a manner that the open and close door is not openable, even if there is a request to unload and load (replace) the battery packs. However, if the open and close door is locked so as not to be openable when the battery packs are supposed to be unloaded and loaded, the battery packs are unable to be unloaded and loaded, and an operator may not be able to take an appropriate measure due to difficulty in handling the situation.

It is therefore a primary object of the present disclosure to allow an operator to take an appropriate measure when a lid of a battery case is locked so as not to be openable in response to a request from an electrified vehicle at the time of battery replacement.

An electrified vehicle of the present disclosure includes at least one replaceable battery and an electric motor configured to transfer electric power to and from the battery, and is configured to travel with power from the electric motor. The electrified vehicle includes:
a battery case including a case body having an opening through which the battery is to be inserted and removed, and a lid configured to open and close the opening of the case body;
a lock device configured to lock the lid in such a manner that the lid is not openable; and
a notification device configured to notify that the lid is locked when the lid is locked by the lock device so as not to be openable in response to a request from the electrified vehicle.

In the electrified vehicle of the present disclosure, when the lid is locked by the lock device so as not to be openable in response to a request from the electrified vehicle, the notification device notifies that the lid is locked. The battery case houses the replaceable battery. An operator who is going to replace the battery can thus determine whether the lid of the battery case is locked by the lock device based on the notification from the notification device. As a result, the operator can take an appropriate measure when the lid of the battery case is locked so as not to be openable in response to a request from the electrified vehicle at the time of battery replacement. For example, the operator may wait until the lid is unlocked by the lock device, or may request repair of the battery without touching the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an electrified vehicle of the present disclosure;

FIG. 2 is a schematic configuration diagram illustrating a battery case included in the disclosed electrified vehicle;

FIG. 3 is a perspective view of a battery case lock device included in the disclosed electrified vehicle;

FIG. 4 is a control diagram of the disclosed electrified vehicle;

FIG. 5 is a time chart for explaining a welding determination process of a battery relay in the disclosed electrified vehicle; and

FIG. 6 is a flow chart illustrating an exemplary routine executed when a startup switch is turned off in the disclosed electrified vehicle.

### DETAILED DESCRIPTION OF EMBODIMENTS

Embodiments of the present disclosure will now be described with reference to the drawings.

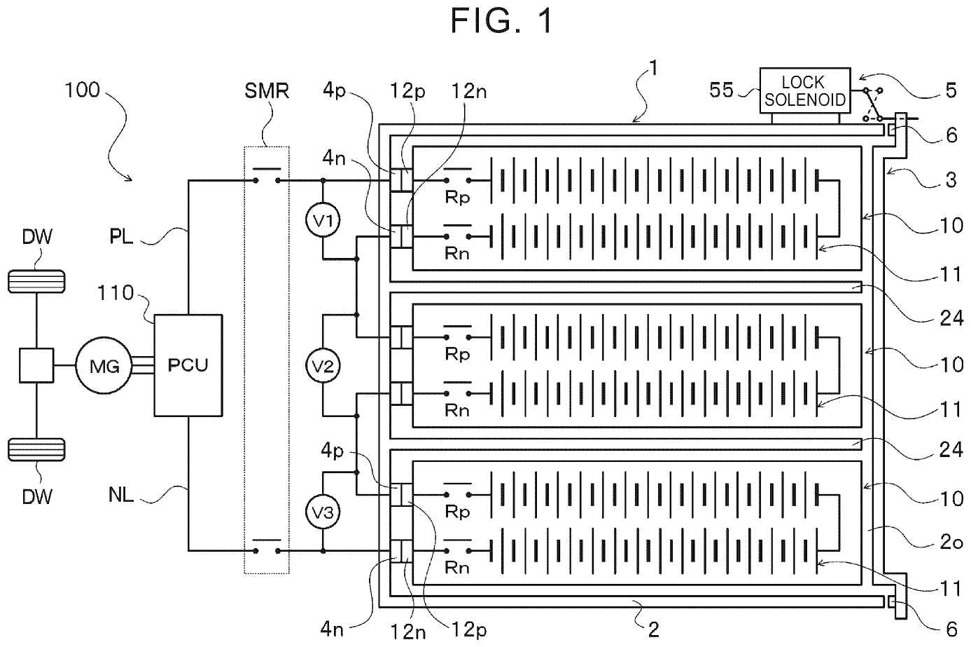

FIG. 1 is a schematic configuration diagram illustrating an electrified vehicle 100 of the present disclosure. Electrified vehicle 100 shown in the drawing is a battery electric vehicle (BEV) including a plurality of replaceable batteries 10, a system main relay SMR which is a normally open mechanical relay (reed relay), a power control device (hereinafter referred to as “PCU”) 110, and a motor generator MG. PCU 110 includes an inverter (drive circuitry) that drives the motor-generator MG, a boost converter, a DC/DC converter, and the like. The motor-generator MG is a synchronous generator motor (three-phase alternating current (AC) motor).

The rotor of the motor-generator MG is coupled to a drive shaft that rotates integrally with a drive wheel DW via a power transmission including a reduction gear and a differential gear. The motor-generator MG is driven by electric power from PCU 110 (battery 10) and outputs a driving torque (driving force) to the driving wheel DW. In addition, the motor generator MG outputs regenerative braking torque to the drive wheel DW at the time of braking electrified vehicle 100, and electric power generated (regenerated) by the motor generator is stored in the plurality of batteries 10.

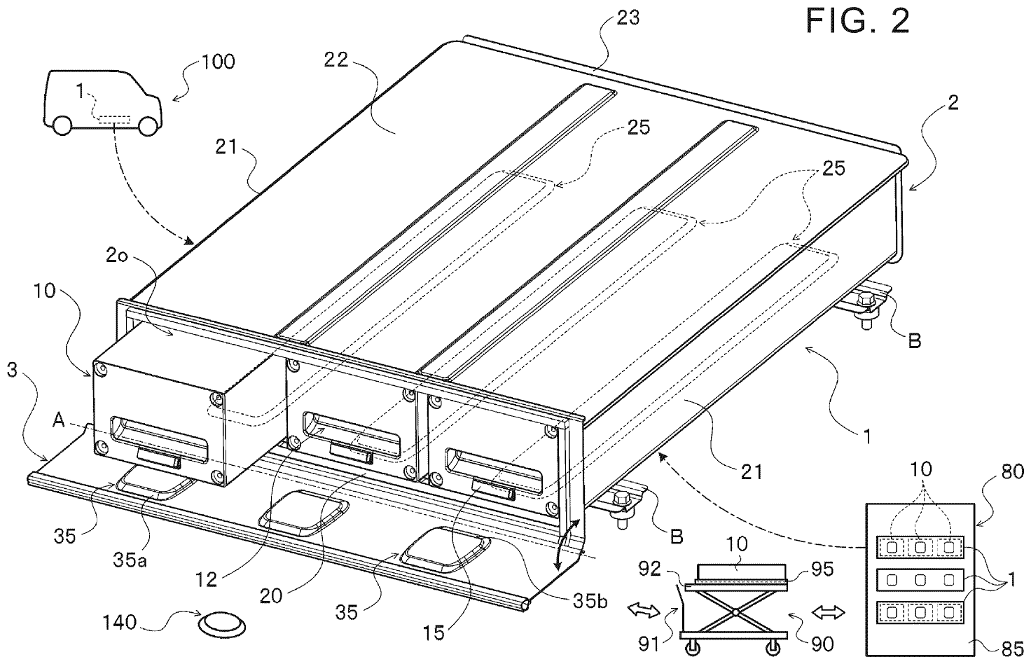

In the present embodiment, electrified vehicle 100 is a commercial vehicle used for, for example, delivery of baggage. The plurality of batteries 10 mounted on electrified vehicle 100 are replaced with the plurality of fully charged batteries 10 in response to a decrease in SOC. The plurality of batteries 10 are charged by a battery charging device 80 (see FIG. 2) outside the vehicle installed in a collection and delivery station of a package, a parking facility of an electrified vehicle 100, or the like. In addition, in a collection and delivery station or the like, the plurality of batteries 10 are taken in and out of electrified vehicle 100 or the battery charging device 80 by using the battery carrying carriage 90 (see FIG. 2).

The plurality of batteries 10 each include a pack case having a substantially rectangular parallelepiped shape and a plurality of battery cells 11 accommodated in the pack case, and have the same specifications (including dimensions) as each other. The battery cell 11 of each battery 10 is, for example, a lithium ion secondary battery cell or a nickel hydrogen secondary electron cell. In the present embodiment, the plurality of battery cells 11 are connected in series in the pack case to form a cell stack. In addition, the positive terminal of the cell stack is electrically connected to the positive-side connector 12p via a mechanical (reed) battery relay Rp. The negative terminal of the cell stack is electrically connected to the negative-side connector 12n via a mechanical battery relay Rn.

As shown in FIG. 1, electrified vehicle 100 includes a battery case 1 in which a plurality of (in the present embodiment, for example, three) replaceable batteries 10 are accommodated in a parallel-arranged manner. The battery case 1 is fixed on the floor panel (vehicle body) of electrified vehicle 100 via a plurality of brackets B (see FIG. 2) so as to be positioned behind the front seat of electrified vehicle 100, for example. Thus, the battery accommodating portion of electrified vehicle 100 is defined. The battery case 1 includes a bottomed rectangular tubular case body 2 having an opening 2o, and a lid 3 that opens and closes an opening 2o of the case body 2. In the present embodiment, the case body 2 of the battery case 1 is fixed to the floor panel such that the opening 2o faces, for example, a side surface of electrified vehicle 100 on the driver's seat side.

A plurality of positive-electrode-side receptacles 4p and a plurality of negative-electrode-side receptacles 4n are disposed inside the case body 2 of the battery case 1. The plurality of positive-electrode-side receptacles 4p can be coupled to the corresponding positive-side connector 12p of the battery 10. The plurality of negative-electrode-side receptacles 4n can be coupled to the respective negative-side connector 12n of the battery 10. The plurality of batteries 10 are connected in series via two sets of positive-electrode-side receptacles 4p and negative-side receptacles n electrically connected to each other. Further, the positive-electrode-side receptacle 4p that is not connected to the negative-electrode-side receptacle 4n is electrically connected to the positive-electrode-side power line PL via the positive-electrode-side relay of the system main relay SMR. The negative-electrode-side receptacle 4n that is not connected to the positive-electrode-side receptacle 4p is electrically connected to the negative-electrode-side power line NL via the negative-electrode-side relay of the system main relay SMR. Further, the positive-side power line PL and the negative-side power line NL are electrically connected to PCU 110. When the system main relay SMR is closed, PCU 110 is electrically connectable to the plurality of batteries 10. In addition, a voltage sensor V1, V2, V3 is installed in the vicinity of the battery case 1 of the floor panel of electrified vehicle 100 or in the battery case 1. The voltage sensor V1, V2, V3 detects a voltage between the positive-electrode-side receptacle 4p and the negative-electrode-side receptacle 4n disposed in the back case of the corresponding battery 10.

As shown in FIG. 2, the case body 2 of the battery case 1 is formed of, for example, a plurality of metal plates that are press-processed. The case body 2 includes a bottom portion 20, a pair of side wall portions 21 extending upward from corresponding side edges of the bottom portion 20, a ceiling portion 22 facing the bottom portion 20 at a distance from each other, and an end wall portion 23. The bottom portion 20, the pair of side wall portions 21, and the ceiling portion 22 form a flat square tube, and the end wall portion 23 closes one end portion of the square tube. As a result, a rectangular opening 2o is defined at the end of the case body 2 that faces away from the side of the end wall portion 23. In addition, the plurality of positive-electrode-side receptacles 4p and the plurality of negative-electrode-side receptacles 4n are disposed so as to be respectively close to the end wall portion 23. Note that the bottom portion 20 and the pair of side wall portions 21 of the case body 2 may be integrally formed, or they may be separately formed and fixed to each other.

Inside the case body 2, a plurality of (three) batteries 10 are accommodated so as to be aligned along the longitudinal direction (width direction) of the opening 2o as the inserting opening. That is, the batteries 10 are inserted into and removed from the case body 2 through the opening 2o in the extending direction of the pair of side wall portions 21. In addition, a plurality of partition walls 24 (see FIG. 1) are disposed inside the case body 2 so as to be positioned between adjacent batteries 10. Furthermore, the case body 2, in order to be accommodated by easily positioning the battery 10 with respect to the battery case 1, a plurality of (in this embodiment, for example, three) case-side guide portions 25 having the same height and width is provided in the case body 2.

As shown in FIG. 2, the plurality of case-side guide portions 25 extend from the side of the opening 2o toward the side of the end wall portion 23 (the inside of the case body 2) in parallel to the respective side wall portions 21. At the same time, the plurality of case-side guide portions 25 are arranged at the bottom portion 20 so as to be spaced apart from each other in the longitudinal direction (widthwise direction) of the opening 2o. In the present embodiment, each case-side guide portion 25 is formed by press working so as to protrude from the inner surface (upper surface) of the bottom portion 20, which is the inner bottom surface of the case body 2, toward the inner side of the case body 2, that is, toward the ceiling portion 22. Each case-side guide portion 25 is located below the central portion in the width direction of each battery 10 accommodated in the case body 2. Further, the upper surface of each case-side guide portion 25 is formed flat, the end portion on the side of the opening 2o and the end portion on the side of the end wall portion 23 of each case-side guide portion 25, an inclined surface for continuing the inner surface of the upper surface and the bottom portion 20 is formed.

The lid 3 is formed of, for example, a pressed metal plate, and is rotatably supported around the rotation shaft A (see FIG. 2) by the case body 2 via a plurality of hinges (not shown). The rotation shaft A extends along a lower edge of the opening 2o, i.e. along one side of the bottom portion 20 defining the opening 2o. As a result, the lid 3 is rotated from the top to the bottom around the rotation shaft A (tilted toward the front), whereby the lid 3 can be opened to expose the opening 2o. Further, by rotating (flipping up) the lid 3 from the bottom to the top around the rotation shaft A, the lid 3 can be closed and the opening 2o can be closed.

Further, as shown in FIG. 2, the lid 3, so as to align with the case-side guide portion 25 corresponding when the lid 3 is opened (fully opened), a plurality of (in the present embodiment, for example, three) lid side guide portions 35 having the same height and width are disposed. Each of the plurality of lid-side guide portions 35 protrudes from the inner surface of the lid 3 toward the inner side of the case body 2. At the same time, the plurality of lid-side guide portions 35 are formed by press working so as to be arranged at intervals in the longitudinal direction (width direction) of the lid 3. The plurality of lid-side guide portions 35 are located below the central portion in the width direction of each battery 10 to be inserted and removed from the case body 2. Further, the upper surface of each lid-side guide portion 35 is formed flat, and is included in substantially the same plane as the upper surface of the case-side guide portion 25 corresponding to when the lid 3 is opened (fully opened). Further, the end portion on the free end side of the lid 3 of the lid-side guide portion 35, the inclined surface 35a for continuing the inner surface of the lid 3 and the upper surface of the lid-side guide portion 35 is formed. An inclined surface 35b for continuing the upper surface of the lid-side guide portion 35 and the inner surface of the lid 3 is formed at an end portion of the lid-side guide portion 35 on the side of the rotation shaft A.

Each battery 10 includes a guided portion (not shown) that engages with the case-side guide portion 25 of the case body 2 and the lid-side guide portion 35 of the lid 3. In the present embodiment, the guided portion is a pair of ridges (rails) protruding downward from the bottom surface of the battery 10 (pack case) and extending in the longitudinal direction of the battery 10. The pair of ridges extend parallel to each other at a distance slightly larger than the width of the case-side guide portion 25 and the lid-side guide portion 35, and are in sliding contact with the corresponding side surfaces of the case-side guide portion 25 and the lid-side guide portion 35 and the inner surface of the bottom portion 20, respectively. Further, an abutting member 15 (see FIG. 2) formed of an elastic body such as rubber or resin is provided on at least one end face of each battery 10 (pack case). The abutting member 15 is disposed below the handle portion 14 of the battery 10, and has a surface inclined so as to be separated from the end surface of the battery 10 from the upper surface side toward the bottom surface side of the battery 10.

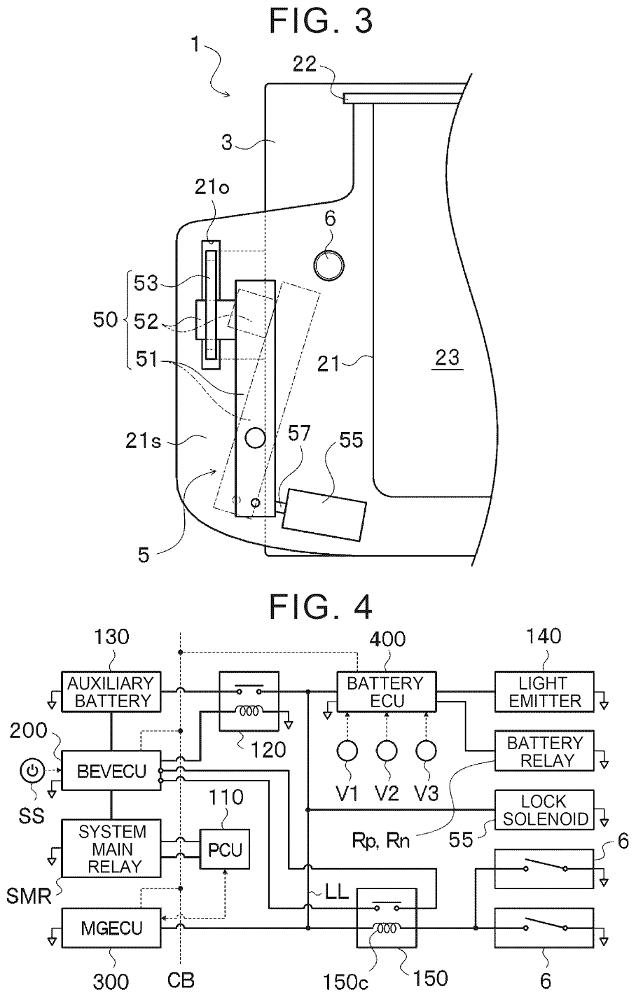

In addition, the case body 2 of the battery case 1 is provided with a lock device 5 that locks the lid 3 with the opening 2o closed so as not to be openable, and two courtesy switches 6 that detect the opening and closing of the lid 3. As shown in FIG. 3, the lock device 5 includes a lock mechanism 50 and a lock solenoid 55 that drives the lock mechanism 50 to form a locked state in response to energization. The lock mechanism 50 selectively forms an unlocked state (refer to a two-dot chain line in the figure) that allows the lid 3 to be opened and a locked state (refer to a solid line in the figure) that restricts the lid 3 from being opened.

The lock mechanism 50 of the lock device 5 includes a lock lever 51 and an engaged portion 53 fixed to the lid 3. The lock lever 51 is disposed on the side of the end wall portion 23 (front side in FIG. 3) of the support portion 21s supported by the one side wall portion 21 of the case body 2 so as to extend parallel to the closed lid 3. In addition, a central portion of the lock lever 51 in the longitudinal direction is rotatably supported by the support portion 21s about an axis extending in parallel to the side wall portion 21. The engaged portion 53 is fixed to one end of the lid 3 so as to be inserted into an opening 210 formed in an outer end portion of the support portion 21s when the lid 3 is closed (fully closed). Further, at one end (upper end) of the lock lever 51, an engaging portion 52 engageable with the engaged portion 53 of the lid 3 inserted into the opening 210 is formed.

The lock solenoid 55 is a pull solenoid that draws a plunger connected to the shaft 57 into the coil in response to energization. The lock solenoid 55 is fixed to the surface on the side of the end wall portion 23 of the support portion 21s such that the shaft 57 protrudes outward from the side wall portion 21. The shaft 57 of the lock solenoid 55 is rotatably coupled to the other end (lower end) of the lock lever 51 via a pin coupling portion. As a result, the lid 3 is closed (fully closed) and a current is supplied to the lock solenoid 55 (coil). Then, as the shaft 57 is drawn toward the coil side, the engaging portion 52 of the lock lever 51 rotates toward the opening 210, and engages with the engaged portion 53 protruding from the opening 210 toward the side of the end wall portion 23. As a result, while the lock solenoid 55 is energized, the lid 3 is unlocked by the lock device 5. It should be noted that the lock device 5 may include a push solenoid.

The two courtesy switches 6 are attached to the other side wall portion 21 of the support portion 21s or the case body 2 so as to be able to abut the corresponding one of both end portions of the lid 3. Each of the courtesy switches 6 is a push-type opening/closing switch that is pressed and closed by the closed lid 3 and is opened in response to opening of the lid 3. Further, in the present embodiment, each of the courtesy switches 6 is grounded so as to form a closed circuit when closed.

The battery case 1 configured as described above is also used in the battery charging device 80. That is, in the housing 85 of the battery charging device 80, a plurality of battery cases 1 are arranged, for example, in the vertical direction so as to define a battery accommodating portion of the battery charging device 80 (see FIG. 2). In addition, in the present embodiment, the battery carrying carriage 90 includes a battery placing plate 95 corresponding to a case in which both of the pair of side wall portions 21 are partially removed from the bottom portion 20 of the case body 2 integrated with the pair of side wall portions 21. The battery carrying carriage 90 includes a base frame, a carriage body 91, and a top plate 92, and the battery placing plate 95 is supported by the top plate 92 (the carriage body 91). The carriage body 91 includes a plurality (at least three) of casters, handles, and the like. The top plate 92 is supported by a carriage body 91 (base frame) so as to be movable up and down via an elevating mechanism (lifter).

FIG. 4 is a control diagram of electrified vehicle 100. As shown in the drawing, electrified vehicle 100 includes an overall electronic control unit (hereinafter referred to as “BEVECU”) 200, a motor electronic control unit (hereinafter referred to as “MGECU”) 300 for controlling PCU 110, and a battery electronic control unit (hereinafter referred to as “battery ECU”) for managing the plurality of batteries 10. Each of BEVECU 200, MGECU 300 and the battery ECU 400 includes a microcomputer having a CPU, ROM, RAM, an input/output interface, and the like (not shown), various driving circuitry, various logic IC, and the like. Both BEVECU 200, MGECU 300 and the battery ECU 400 exchange data (communication frames) with each other via a shared communication line (CAN bus) CB or the like.

Various sensors such as a start switch (IG switch) SS, an accelerator pedal position sensor, a shift position sensor, and a vehicle speed sensor are connected to BEVECU 200. When electrified vehicle 100 is traveling, BEVECU 200 sets a required torque required for traveling on the basis of the accelerator operation amount and the vehicle speed. At the same time, BEVECU 200 sets a torque command or the like for the motor-generator MG based on the required torque or the like. Further, BEVECU 200 controls opening and closing of the system main relay SMR and the power supply relay (IGCT relay) 120.

The power supply relay 120 is a normally open mechanical relay (reed relay). For example, the power supply relay 120 is capable of electrically connecting an auxiliary battery (low voltage battery) 130 of a electrified vehicle 100 having a rated output voltage of about 12V and DC/DC converters of a PCU 110 to a low voltage power line LL to which a plurality of auxiliary machines including a MGECU 300, a battery ECU 400, and the like are connected. When electrified vehicle 100 driver turns on the start switch SS and requests electrified vehicle 100 to start up the system, BEVECU 200 supplies an exciting current based on the electric power from the auxiliary battery 130 or the like to the coil of the power supply relay 120 to close the power supply relay 120. By closing the power supply relay 120, electric power from the auxiliary battery 130 or the like is supplied to the various auxiliary machines.

Further, BEVECU 200 closes the power supply relay 120 and then executes predetermined processes such as the welding determination, the overheat determination, and the electric leakage determination of the system main relay SMR. When the predetermined ready-on condition is satisfied, BEVECU 200 closes the system main relay SMR. In this situation, BEVECU 200 supplies the excitation current based on the electric power from the auxiliary battery 130 or the like to the coils of the system main relay SMR (the positive-side relay and the negative-side relay) to close the system main relay SMR. When a failure such as the system main-relay SMR being welded (having failed in a closed position) occurs at the time of system startup, the BEVECU 200 turns on a predetermined warning light on a display provided on the instrument panel. At the same time, BEVECU 200 transitions electrified vehicle 100 to the corresponding fail-safe mode.

Further, BEVECU 200 shuts off the excitation current and opens the system main relay SMR when the driver turns off the start switch SS and requires electrified vehicle 100 to be shut down. Thereafter, BEVECU 200 executes predetermined processes such as the welding determination, the overheat determination, and the electric leakage determination of the system main relay SMR, and when the predetermined conditions are satisfied, shuts off the supplying of the excitation current and opens the power supply relay 120. If a failure occurs, such as welding of the system main-relay SMR, when system shutdown is requested, BEVECU 200 turns on the predetermined fail flag and then shuts down electrified vehicle 100. Electrified vehicle 100 then transitions to the fail-safe mode when the start switch SS is next turned on. In electrified vehicle 100, the display of the instrument panel is turned off when the start switch SS is turned off.

As illustrated in FIG. 4, the battery ECU 400 acquires a detected value of the voltage sensor V1, V2, V3 provided for each of the plurality of batteries 10. Further, the battery ECU 400 is electrically connected to the battery relays Rp, Rn of the respective batteries 10 via connectors and receptacles (not shown) and a power supply line. While the power supply relay 120 is closed, the battery ECU 400 supplies an exciting current based on electric power supplied from the auxiliary battery 130 or the like to the coils of the respective battery relay Rp, Rn via the power supply relay 120. As a result, the battery relays Rp, Rn are closed. Further, the battery ECU 400 may cut off the energization current to open the respective battery relaying Rp, Rn. When at least one of the battery relay Rp, Rn is opened, even if the system main relay SMR is closed, a plurality of batteries 10, a PCU 110, a motor generator MG, and the like are included (closed circuit).

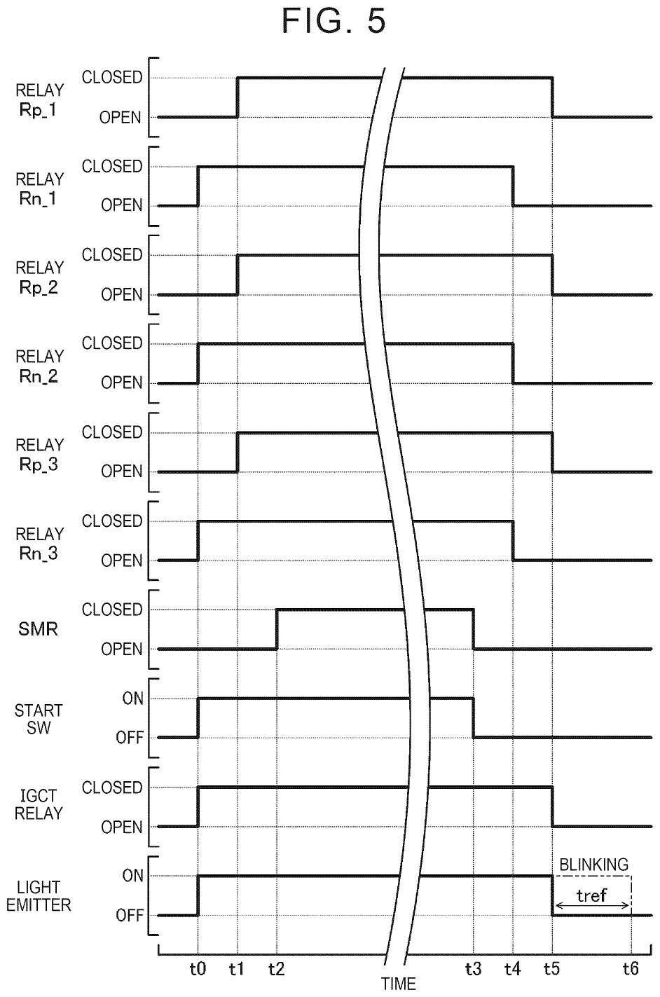

After the power supply relay 120 is closed in response to the start switch SS being turned on (and before the system main relay SMR is closed) and after the system main relay SMR is opened in response to the start switch SS being turned off, the battery ECU 400 determines whether or not the battery relay Rp,Rn of the respective batteries 10 has been welded (have failed in a closed position). That is, when the start switch SS is turned on and the power supply relay 120 is closed, the battery ECU 400 determines whether or not one of the battery relay Rp, Rn (for example, the battery relay Rp) of the respective batteries 10 is welded, as illustrated in FIG. 5. Note that the relays Rp_1 and Rn_1 in FIG. 5 indicate the battery relay Rp, Rn of the first battery 10. The relays Rp_2 and Rn_2 indicate the battery relay Rp, Rn of the second battery 10. The relays Rp_3 and Rn_3 indicate the battery relay Rp, Rn of the third battery 10.

Specifically, when the power supply relay 120 is closed, the battery ECU 400 closes only the other battery relay Rp, Rn (for example, the battery relay Rn) of the respective batteries 10 (time t0 in FIG. 5). The battery ECU 400 determines whether or not one of the battery relays Rp, Rn of the respective batteries 10 is welded, based on the detected value of the voltage sensor V1, V2, V3. When both of the detected values of the voltage sensor V1, V2, V3 are zero, the battery ECU 400 as the failure determination device determines that one of the battery relay Rp, Rn of each battery 10 is not welded, and closes one of the battery relay Rp, Rn of each battery 10. At the same time, the territory ECU 400 transmits a notification of permission to close the system main relay SMR to BEVECU 200 (time t1 in FIG. 5). In this case, BEVECU 200 closes the system main relay SMR on condition that the system main relay SMR or the like is normal (time t2 in FIG. 5). On the other hand, the battery ECU 400 turns on a predetermined warning light on the display provided on the instrument panel when the battery ECU 400 determines that at least one of the battery relays Rp, Rn of the respective batteries 10 is welded on the basis of the detected value of the voltage sensors V1, V2, V3. At the same time, the battery ECU 400 transitions electrified vehicle 100 to a corresponding fail-safe mode.

Further, when the start switch SS is turned off and the system main relay SMR is opened (time t3 in FIG. 5), the battery ECU 400 determines whether or not the other of the battery relays Rp, Rn (for example, the battery relay Rn) of the respective batteries 10 is welded. Specifically, when the system main relay SMR is opened, the battery ECU 400 opens only the other of the battery relay Rp, Rn of the respective batteries 10 (time t4 in FIG. 5). The battery ECU 400 determines whether or not the other of the battery relays Rp, Rn of the respective batteries 10 is welded based on the detected value of the voltage sensor V1, V2, V3. When the detected values of the voltage sensors V1, V2, V3 are all zero, the battery ECU 400 as the failure determination device determines that the other of the battery relays Rp, Rn of the respective batteries 10 is not welded. The battery ECU 400 opens one of the battery relays Rp, Rn of the respective batteries 10 and transmits a notification of opening permission of the power supply relay 120 to BEVECU 200 (time t5 in FIG. 5). Upon receiving the opening permission notification from the battery ECU 400, BEVECU 200 opens the power supply relay 120 on condition that the system main relay SMR or the like is normal.

Further, as shown in FIG. 4, the lock solenoid 55 (coil) of the lock device 5 of the battery case 1 is connected to the low-voltage power line LL. While the power supply relay 120 is closed, a current from the auxiliary battery 130 or the like is constantly supplied to the lock solenoid 55. As a result, while the power supply relay 120 is closed, the lock solenoid 55 holds the lock lever 51 of the lock mechanism 50 so that the engaging portion 52 is engaged with the engaged portion 53 inserted into the opening 210. As a consequence, the lid 3 of the battery case 1 is locked by the lock device 5 so as not to be openable while the start switch SS is turned on and the power supply relay 120 is closed.

Furthermore, as shown in FIG. 4, the two courtesy switches 6 of the battery case 1 are electrically connected to one end of a coil 150c of an interlock relay (circuit opening/closing relay) 150 via a connector and a receptacle (not shown) and an electric wire. The interlock relay 150 is a mechanical relay (reed relay). The other end of the coil 150c of the interlock relay 150 is connected to the low-voltage power-line LL. One of the two contacts of the interlock relay 150 is electrically connected to the first terminal of BEVECU 200, and the other of the two contacts is electrically connected to the second terminal of BEVECU 200. BEVECU 200 applies a voltage based on electric power from the auxiliary battery 130 or the like to the first terminal during a period from when the start switch SS is turned on to when it is turned off.

When the lid 3 of the battery case 1 is closed and at least one of the two courtesy switches 6 is closed, one end of the coil 150c of the interlock relay 150 is grounded by the courtesy switch 6. Therefore, when the lid 3 of the battery case 1 is closed and the power supply relay 120 is closed, an excitation current based on electric power from the auxiliary battery 130 or the like is supplied to the coil 150c, thereby closing the interlock relay 150. When the interlock relay 150 is closed, the first and second terminals of BEVECU 200 are electrically connected via the interlock relay 150. BEVECU 200 compares the voltages of the first and second terminals and determines that the interlock relay 150 is closed if the voltages of the first and second terminals are approximately the same.

On the other hand, when the lid 3 of the battery case 1 is opened, even if the power supply relay 120 is closed, the energization current to the coil 150c is cut off by opening the respective courtesy switches 6, that is, opening the closing circuit by releasing the grounding. As a result, the interlock relay 150 is opened. Then, the first and second terminals of BEVECU 200 are disconnected from each other, and the voltage of the second terminal becomes zero. BEVECU 200 determines that the lid 3 of the battery case 1 is opened when the voltage of the second terminal drops (drops to zero), and the respective courtesy switches 6 are opened to open the interlock relay 150. BEVECU 200 cuts off supplying the excitation current to the system main relay SMR to open the system main relay SMR. As a result, a high-voltage circuit (closed circuit) including the plurality of batteries 10, PCU 110, the motor-generator MG, and the like is opened.

In addition, as shown in FIG. 4, a light emitter 140 as a notification device is electrically connected to the battery ECU 400. The light emitter 140 includes a light emitting diode or the like. The light emitter 140 is installed in the vicinity of the battery case 1 of electrified vehicle 100 floor panel (see FIG. 2) so as to be identified by an operator (user) who replaces the battery 10 while the lid 3 of the battery case 1 is closed. The vicinity of the battery case 1 of the floor panel of electrified vehicle 100 is, in other words, in front of the lid 3. However, the light emitter 140 may be installed in the battery case 1 as long as it can be identified by an operator in a state where the lid 3 of the battery case 1 is closed. While the start switch SS is turned on and the power supply relay 120 is closed, the battery ECU 400 supplies an exciting current based on the electric power supplied from the auxiliary battery 130 or the like via the power supply relay 120 to the light emitter 140. As a result, the light emitter 140 is turned on (emitted).

That is, in electrified vehicle 100, the lid 3 of the battery case 1 is locked by the lock device 5 so as not to be openable while the start switch SS is turned on and the power supply relay 120 is closed. At the same time, the light emitter 140 installed in the vicinity of the battery case 1 is made to emit light. Therefore, the light emitter 140 functions as a notification device that notifies that the lid 3 of the battery case 1 is locked. In addition, the battery ECU 400 can blink the light emitter 140 by intermittently supplying the exciting current.

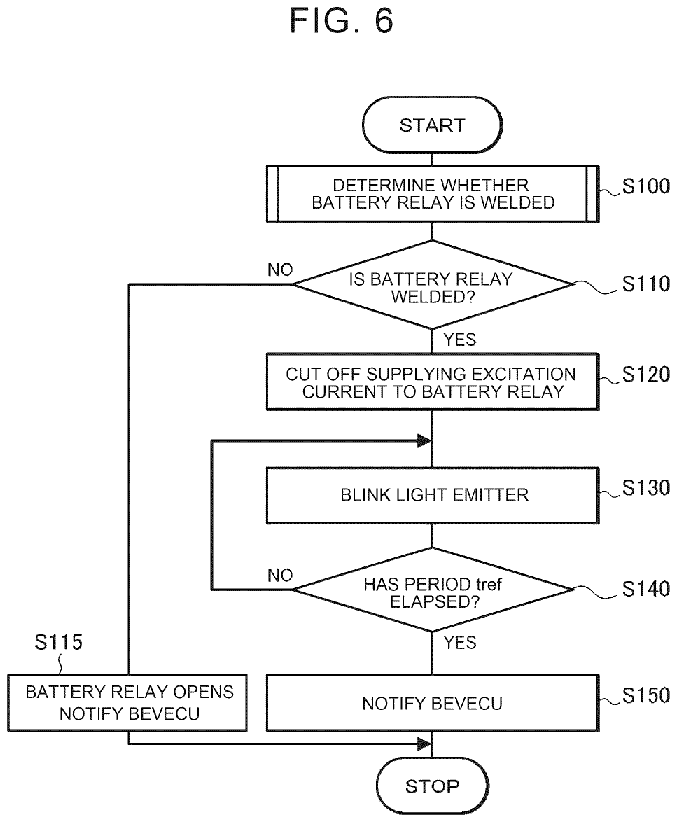

FIG. 6 is a flow chart showing a routine executed by the battery ECU 400 after the start switch SS is turned off and the system main relay SMR is opened.

As described above, when the start switch SS is turned off and the system main relay SMR is opened, the battery ECU 400 as the failure determination device opens only one of the battery relay Rp,Rn (for example, the battery relay Rp) of the respective batteries 10. The battery ECU 400 executes a welding determination process of the other of the battery relay Rp, Rn (for example, the battery relay Rn) (S100). Since the power supply relay 120 is closed while the welding determination process is executed, the lid 3 of the battery case 1 is locked by the lock device 5 so as not to be openable. During this time, an exciting current based on electric power from the auxiliary battery 130 or the like is continuously supplied to the light emitter 140 via the battery ECU 400, and the light emitter 140 is continuously turned on.

When the battery ECU 400 determines that the other battery relay Rp,Rn of each battery 10 is not welded by S100 welding determination process (S110: NO), the battery ECU 400 opens one of the battery relays Rp,Rn of each battery 10. At the same time, the battery ECU 400 transmits a notification of permission to open the power supply relay 120 to BEVECU 200 (S115), and terminates the routine of FIG. 6. Upon receiving the opening permission notification from the battery ECU 400, BEVECU 200 opens the power supply relay 120 on condition that the predetermined process such as the welding determination, the overheat determination, and the electric leakage determination of the system main relay SMR is completed. As a result, the electric power supplied from the auxiliary battery 130 or the like is interrupted, so that the operation of the battery ECU 400 is stopped, and the light emitter 140 that has been lit up until then is turned off.

That is, in electrified vehicle 100, after the start switch SS is turned off and the system main relay SMR is opened, a predetermined process such as the welding determination of the system main relay SMR is executed by BEVECU 200. During this time, the closing of the power supply relay 120 is continued in response to the demand of BEVECU 200 (electrified vehicle 100 side), and the lid 3 of the battery case 1 is locked. If, for example, the system main relay SMR is overheated when the start switch SS is turned off, BEVECU 200 continues to close the power supply relay 120 until the overheating is eliminated, thereby locking the lid 3 of the battery case 1. Furthermore, the lid 3 of the battery case 1 is locked according to the requirements of these BEVECU 200 (electrified vehicle 100 sides). During this time, the light emitter 140 is turned on so as to notify the operator who intends to replace the battery 10 by turning off the start switch SS that the lid 3 is locked.

On the other hand, when S100 welding determination process determines that the battery ECU 400 has welded at least one of the other battery relay Rp,Rn of each battery 10 (S110: YES), the battery ECU 400 cuts off supplying the excitation current to one of the battery relay Rp,Rn of each battery 10 (S120). The battery ECU 400 also blinks the light emitter 140 by intermittently supplying an exciting current to the light emitter 140 (S130). Further, the battery ECU 400 determines whether or not a predetermined warning time (predetermined time) tref has elapsed since the light emitter 140 starts blinking in S130 (S140). The warning time tref is predetermined as a time sufficient to cause an operator who intends to replace the battery 10 to recognize the flashing of the light emitter 140 after the start switch SS is turned off.

If the warning period tref has not elapsed since the flashing of the light emitter 140 (S140: NO), the battery ECU 400 continues the supply of the exciting current to the light emitter 140 (S130) and performs S140 process again. In addition, when the warning period tref has elapsed since the flashing of the light emitter 140 (S140: YES), the battery ECU 400 transmits a notification of permission to open the power supply relay 120 to BEVECU 200 (S150), and ends the routine of FIG. 6. Upon receiving the opening permission notification from the battery ECU 400, BEVECU 200 opens the power supply relay 120 in accordance with the condition of completion of a predetermined process such as the welding determination, the overheat determination, and the electric leakage determination of the system main relay SMR. As a result, since the electric power supplied from the auxiliary battery 130 or the like is interrupted, the operation of the battery ECU 400 is stopped, and the light emitter 140 that has been blinking up to that time is turned off (see the time t6 in FIG. 5).

That is, in electrified vehicle 100, when it is determined by the battery ECU 400 that at least one of the other of the battery relay Rp,Rn of the respective batteries 10 is welded (S110: YES) after the start switch SS is turned off and the system main relay SMR is opened, the closing of the power supply relay 120 is continued in response to a request from the battery ECU 400 (electrified vehicle 100. As a result, the lid 3 of the battery case 1 is locked. Closing of the power supply relay 120 is continued until at least a predetermined alert-time tref has elapsed (S140: NO). Furthermore, the lid 3 of the battery case 1 is locked in response to a requirement of the battery ECU 400 (electrified vehicle 100). During this time, the light emitter 140 is made to blink in order to notify the operator who is going to replace the battery 10 by turning off the start switch SS to the effect that the lid 3 is locked.

As described above, electrified vehicle 100 includes a plurality of replaceable batteries 10 and a motor-generator MG that exchanges power with the plurality of batteries 10. Electrified vehicle 100 can be driven by power from the motor-generator MG. Further, electrified vehicle 100 includes a battery case 1 including a case body 2 having an opening 2o into which a plurality of batteries 10 are inserted and removed, and a lid 3 that opens and closes an opening 2o of the case body 2. Electrified vehicle 100 includes a lock device 5 for locking the lid 3 in such a manner that the lid 3 is not openable, and a light emitter 140 as a notification device for notifying that the lid 3 is locked. After the start switch SS is turned off, the lock device 5 locks the lid 3 of the battery case 1 containing the replaceable battery 10 in such a manner that the lid 3 is not openable in response to a request from electrified vehicle 100. At this time, the light emitter 140 is turned on or flashed so as to notify the operator that the lid 3 is locked. The request from electrified vehicle 100 is the request from BEVECU 200 or the battery ECU 400.

As a result, the operator who intends to replace the battery 10 can determine whether or not the lid 3 of the battery case 1 is locked by the lock device 5 based on the lighting or blinking (light emission mode) of the light emitter 140. As a consequence, the lid 3 of the battery case 1 is locked so as not to be openable in response to a request from electrified vehicle 100, i.e., BEVECU 200, at the time of battery replacement, and the light emitter 140 is turned on. At this time, the worker can take appropriate measures such as waiting until the lock of the lid 3 by the lock device 5 is released.

Further, when it is determined that at least one of the battery relays Rp,Rn is welded (has failed in a closed position) by the battery ECU 400 as the failure determination device (S110: YES), the light emitter 140 notifies that the lid 3 is locked in a different manner (blinking). The different mode is a mode different from the mode (lighting) of (S110: NO) when it is determined that at least one of the battery relaying Rp, Rn is not welded by the battery ECU 400. Thus, the operator who intends to replace the battery 10 determines whether or not the lid 3 of the battery case 1 is locked due to the welding of the battery relay Rp or Rn from the light emission mode (notification mode) of the light emitter 140. At the same time, the operator can take appropriate measures such as requesting repair of the battery 10 without touching the battery 10, for example.

Further, when at least one of the battery relays Rp, Rn is welded (S110: YES), the lid 3 of the battery case 1 is locked by the lock device 5 so as not to be openable. At the same time, the blinking of the light emitter 140 notifies that the lid 3 is locked (S130). This satisfactorily reduces the possibility that the operator who intends to replace the battery 10 may touch the battery 10 while the high-voltage circuit (closed circuit) is formed in electrified vehicle 100. The high-voltage circuitry includes a plurality of batteries 10, PCU 110, motor-generator MG, and the like.

In addition, the light emitter 140 is turned on so as to notify that the lid 3 is locked while the presence or absence of welding of the battery relay Rp or Rn is determined by the battery ECU 400 as the failure determination device (S100). Then, when it is determined that the battery relay Rp or Rn is welded (S110: YES), the light emitter 140 is caused to blink so as to continuously notify that the lid 3 is locked by at least a predetermined warning period tref, and then turns off. This can reduce the possibility that the light emitter 140 may continuously blink (operating) more than necessary while notifying the operator who intends to replace the battery 10 that the lid 3 of the battery case 1 is locked by the lock device 5.

Further, in electrified vehicle 100, the light emitter 140 is installed in the periphery of the battery case 1 or in the battery case 1 so as to be identified by an operator while the lid 3 is closed. Accordingly, even if the start switch SS is turned off and the display of the instrument panel is turned off, the operator who intends to replace the battery 10 can be more reliably notified of the presence or absence of the lock of the lid 3 of the battery case 1 by the lock device 5. However, when the display of the instrument panel is not turned off even when the start switch SS is turned off, it may be displayed on the display that the lid 3 is locked so as not to be openable. Instead of the light emitter 140, a notification device that notifies by voice that the lid 3 is locked so as not to be openable may be employed.

Further, instead of installing the voltage sensor V1, V2, V3 in electrified vehicle 100 or the battery case 1 described above, a voltage sensor V1, V2 or V3 may be provided in the pack case of the respective batteries 10. The voltage sensor V1, V2 or V3 detects a voltage between the positive-electrode-side receptacle 4p and the negative-electrode-side receptacle 4n. Further, a capacitor may be provided between the positive-electrode-side receptacle 4p and the negative-electrode-side receptacle 4n of the respective batteries 10, and a single voltage sensor may be provided in electrified vehicle 100 or the battery case 1. Further, the batteries 10 may be provided with indicator lights that light up (emit light) when at least one of the battery relaying Rp, Rn is closed. Further, the battery case 1 may be mounted on a moving object other than an electrified vehicle 100 such as a railcar, or may be installed in a fixed facility other than the battery charging device 80. Further, the battery case 1 may be configured to accommodate a single replaceable battery 10. The case body 2 of the battery case 1 may be defined by an electrified vehicle 100 vehicle body. A part of the case body 2 may be formed by a part of a vehicle body of electrified vehicle 100.

It is needless to say that the present disclosure is not limited to the above-described embodiments, and various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The present disclosure is applicable to the manufacturing industry of electrified vehicle and the like.

What is claimed is:

1. An electrified vehicle including at least one replaceable battery and an electric motor that transfers electric power to and from the battery, and configured to travel with power from the electric motor, the electrified vehicle comprising:
a battery case including a case body having an opening through which the battery is to be inserted and removed, and a lid configured to open and close the opening of the case body;
a lock device configured to lock the lid in such a manner that the lid is not openable; and
a notification device configured to notify that the lid is locked when the lid is locked by the lock device so as not to be openable in response to a request from the electrified vehicle.

2. The electrified vehicle according to claim 1, wherein the notification device is installed around the battery case or on the battery case so as to be identified by a user with the lid closed.

3. The electrified vehicle according to claim 1, further comprising a power control device configured to be electrically connected to the battery, wherein
the battery includes a relay configured to electrically disconnect the battery from the power control device, and
when the relay has failed in a closed position, the lock device locks the lid in such a manner that the lid is not openable, and the notification device notifies that the lid is locked.

4. The electrified vehicle according to claim 3, further comprising a failure determination device configured to, when a start switch of the electrified vehicle is turned off, determine whether the relay of the battery has failed in the closed position, with the lid locked by the lock device so as not to be openable, wherein the notification device is configured to notify that the lid is locked while the failure determination device is determining whether the relay has failed in the closed position, and is configured to, when the failure determination device determines that the relay has failed in the closed position, continuously notify for at least a predetermined time that the lid is locked.

5. The electrified vehicle according to claim 4, wherein the notification device is configured to, when the failure determination device determines that the relay has failed in the closed position, notify that the lid is locked in a different manner from when the failure determination device determines that the relay has not failed in the closed position.
